(19) United States
(12) Patent Application Publication
(10) Pub. No.: US 2020/0206899 A1
(43) Pub. Date: Jul. 2, 2020

(54) HUMAN EXOSKELETON

(71) Applicant: HAWE Altenstadt Holding GmbH, Altenstadt (DE)

(72) Inventors: Martin Storz, Schwabsoien (DE); Gerhard Rinninger, Kaufbeuren (DE)

(21) Appl. No.: 16/644,724

(22) PCT Filed: Mar. 12, 2019
(86) PCT No.: PCT/EP2019/056083

§ 371 Date: Mar. 5, 2020

(30) Foreign Application Priority Data
Mar. 22, 2018 (DE) 10 2018 106 846.8

(51) Int. Cl. B25J 9/00; B25J 9/14

(52) U.S. Cl. CPC B25J 9/0006; A61H 2201/165; A61H 2201/1246; B25J 9/144

(57) ABSTRACT

A human exoskeleton includes a first skeletal structure with a first coupling unit for coupling to a first part of a human body, a second skeletal structure connected to the first skeletal structure in an articulated manner and including a second coupling unit for coupling to a second part of the human body. An adjustment unit acts between the first and second skeletal structures, and includes at least one adjustable flow rate hydraulic actuator unit and a hydraulic unit that acts thereon and which has two pump connections. The first pump connection is fluidly connected to a working chamber of the actuator unit via a pressure line. An outlet line has a flow throttle and a calming tank is downstream of the throttle. The first pump connection is fluidly connected to the second pump connection via the outlet line and the calming tank, the outlet line having a flow therethrough when pressure is applied to the working chamber.

### CROSS-REFERENCE TO RELATED APPLICATIONS

This application is the U.S. national stage of PCT/EP2019/056083 filed Mar. 12, 2019, which claims priority of German Patent Application 10 2018 106 846.8 filed Mar. 22, 2018 both of which are hereby incorporated by reference in their entirety.

### FIELD OF THE INVENTION

The present invention relates to a human exoskeleton for coupling to a human body, comprising a first skeletal structure with a first coupling unit which is suitable for coupling to a first part of the human body, a second skeletal structure which is connected thereto in an articulated manner and which has a second coupling unit suitable for coupling it to a second part of the human body, and an adjustment unit acting between the first skeletal structure and the second skeletal structure and having at least one hydraulic actuator unit and a hydraulic unit which acts on the latter and which has two pump connections.

### BACKGROUND OF THE INVENTION

Human exoskeletons of the above type are known from the prior art, for example from EP 1991180 B1, WO 2010/00547 3 A1 and WO 2010/019300 A1. They are in practical use in two main applications. In particular, they may be used in a mobile way to support the body's functions, in particular to provide an additional force to strengthen the muscular strength of the person carrying the exoskeleton. Other applications are primarily stationary, especially in the rehabilitation and/or training sector; here it can be a matter of both a targeted build-up of the body's own movement function through controlled active influence of the exoskeleton and strengthening the body muscles by moving the body parts to be trained against a controlled braking force provided by the (passively working) exoskeleton. A typical area of application is for example the leg, where one of the two skeletal structures of the exoskeleton is coupled to the thigh and the other skeletal structure to the lower leg.

### SUMMARY OF THE INVENTION

The present invention has the object of providing an exoskeleton of the generic type which is particularly suitable for applications in the field of rehabilitation and which, due to its inherent operational characteristics, contributes to particularly favorable developments in the progress of rehabilitation.

This problem is solved in that the hydraulic unit of a exoskeleton has an adjustable flow rate and in that a first pump connection is fluidically connected to a working chamber of the actuator unit via a pressure line and also is fluidically connected to the second pump connection via an outlet line with a flow therethrough when pressure is applied to said working chamber and into which a flow throttle is integrated and a calming tank downstream of the flow throttle. Depending on the individual application situation in sense of an adjustment or a maintenance of the position of the two skeletal structures of the exoskeleton relative to each other, the amount of the adjustment force and holding force delivered by the actuator unit is varied by adjusting the flow rate of the hydraulic unit by creating a specific pressure drop in dependence on the flow rate at the flow throttle of the outlet line, which is flowed through when the said working chamber of the actuator unit is pressurized, which in turn influences the pressure level on the inflow side of the flow throttle and thus in the pressurized working chamber of the hydraulic (hydrostatic) actuator unit. In other words, by varying the flow rate of the hydraulic unit, a flow rate-specific or -dependent pressure drop can be set at the flow throttle in the outlet line, which is arranged in the actuator unit “parallel” to the flow to the actuator unit. The calming tank arranged in series with the flow throttle, namely in being downstream thereof, the calming tank, significantly reduces the risk of hydraulic fluid becoming turbulent in the flow throttle is reaching the second pump connection and being sucked in by it. This avoids the formation of outgassing on the pressure side of the hydraulic adjustment unit, which would impair the rigidity of the hydraulic system, and thus promotes optimally reproducible operating characteristics. This is also an essential aspect, especially for applications in the field of rehabilitation.

According to the present invention, an adjustment of the flow rate of the hydraulic unit can, in particular, adjust the force provided by the actuator unit so that it is greater or smaller than the external force, i.e. an adjustment force exerted by the human body on the exoskeleton and acting on the actuator unit, or equal to or greater than the latter. Thus, in response to external forces (e.g. muscular strength of the person carrying the exoskeleton), the two skeletal structures can be adjusted in one direction or the other, or the existing position can be maintained. An active adjustment of the exoskeleton is to be understood as a change in the position of the two skeletal structures against an externally acting force, whereas passive adjustment means a change in the position of the two skeletal structures with an externally acting force, wherein the adjustment unit typically brakes the movement in controller manner during passive adjustment, so that the movement is slower when compared to a movement without an adjustment unit.

The exoskeleton is designed according to the invention, namely as a result of the influence of the flow dynamic conditions at the flow throttle in the outlet line on the working pressure prevailing in the working chamber of the hydrostatic actuator unit, which is dependent on the flow rate of the hydraulic unit, and therefore has a particularly soft operating and working characteristic. Abrupt movements like impacts and the like are avoided, at least the danger of such discontinuities is significantly reduced compared to the known exoskeletons. By eliminating the shocks and other abrupt movements of the two skeletal structures of the exoskeleton relative to each other, which can regularly be painful for the person wearing the exoskeleton, particularly in the rehabilitation sector, and which can lead to cramps that undermine the success of the rehabilitation, the use of the exoskeleton according to the invention favours a rapid and lasting success of the rehabilitation measure in question. These significant advantages justify the efficiency disadvantage of the exoskeleton according to the invention, which results from the permanent circulation of hydraulic fluid through the outlet line (including the flow throttle) during the pressurization of the working chamber of the hydraulic actuator unit by the hydraulic unit. According to a preferred embodiment of the invention (see below), this efficiency disadvantage can be distinctly limited by providing a shut-off valve, which shuts off the pressurized working chamber and with which the hydraulic fluid can be locked in the working chamber, if—without pressurization of the actuator unit by the hydraulic unit and independent of external adjustment forces acting on the skeletal structures—the position of the two skeletal structures relative to each other is to be maintained for a certain period of time.

As a precautionary measure, it should be noted that the characteristics described above, which result from the particular operational and working characteristics of the exoskeleton, are not only beneficial in the rehabilitation sector. Rather, they are equally welcome in other fields of application, e.g. stationary as well as mobile applications. Furthermore, they apply regardless of the specific constructional embodiment of the hydraulic actuator unit. Not only can it comprise at least one linear actuator; rather, for example, the implementation of the present invention with at least one rotary actuator can also be considered.

The adjustability of the flow rate of the hydraulic unit, which is essential for the present invention, can be realized in particular by the fact that, in a preferred embodiment of the invention, the hydraulic unit comprises a variable-speed electric motor or a variable displacement hydraulic pump. Which approach is to be preferred depends on the individual framework conditions that are decisive for the respective application. For example, if a particularly high possible adjustment rate is desired, the use of a variable displacement hydraulic pump is associated with certain advantages; because with corresponding variable displacement pumps, the flow rate can typically be adjusted more quickly than by changing the rotor speed of a pump having a constant flow rate. It is also apparent that the hydraulic unit may comprise a variable-speed electric motor and a variable-displacement hydraulic pump. The increased structural effort of this embodiment is justified by the increased flexibility with regard to the operating conditions and a wider range of possible flow rates (and thus the possible pressurization of the working chamber of the hydraulic actuator unit).

According to another preferred embodiment of the invention, the flow throttle provided in the outlet line is also adjustable in that the pressure drop that occurs at a certain flow rate can be changed. This also contributes to increased flexibility with regard to the operating conditions and a wider range of possible pressurizations of the working chamber of the hydraulic actuator unit.

Another preferred further embodiment of the invention is characterized in that the calming tank is configured as a closed expansion tank. Inside the expansion tank there is advantageously a (compressible) gas volume to compensate for a temperature-related change in volume of the hydraulic fluid absorbed in the hydraulic system. Furthermore, the calming tank preferably comprises heat-conducting internals which are preferably exposed to the hydraulic fluid and which promote the extraction of heat from the hydraulic fluid contained in the calming tank, and the calming tank preferably further comprises a surface design (e.g. in the form of cooling fins) which promotes heat dissipation to the environment. The heat-conducting internals preferably also have a flow guiding function, i.e. they are preferably designed and arranged—in the form of “baffles”—in such a way that they force a maximum dwell time for the hydraulic fluid flowing through the calming tank in circulation mode and in particular prevent flow-related short circuits.

A preferred further embodiment of the invention is characterized in that the hydraulic unit is reversible, that the working chamber (explained above) is a first working chamber, and that the actuator unit comprises a second working chamber acting in the opposite direction to the first working chamber. Thus—by means of targeted and controlled pressurization of the first or second working chamber—both active and passive controlled bidirectional changes in the position of the two skeletal structures relative to each other can be realized, as well as maintaining the given position, in the case of the most varied external influences on the exoskeleton. The energetic efficiency of the system is more favourable than in the (also conceivable) case where a hydraulic force generated by the actuator unit acts in one direction of changing the position of the two skeletal structures in relation to each other, whereas in the opposite direction a—for example purely mechanical—return spring acts, against which the hydraulic part of the actuator unit would have to work permanently. If the actuator unit is configured for bidirectional hydraulic adjustment of the exoskeleton, the second pump connection of the hydraulic unit is preferably fluidically connected to the second working chamber of the actuator unit via a second pressure line and also is fluidically connected to the first pump connection via a second outlet line with a flow therethrough when pressure is applied to said second working chamber and into which a second flow throttle is integrated and a calming tank downstream of second flow throttle. The calming tank having a flow therethrough when the second working chamber is pressurized is preferably identical to the calming tank having a flow therethrough when the first working chamber is pressurized. This means that the adjustment unit requires only one calming tank, which is advantageous in terms of the lowest possible weight and installation space. However, within the scope of the present invention, two separate calming tanks may as well be provided, so that when the second working chamber is pressurized, the hydraulic fluid flowing through the second outlet line is returned to the first pump connection via a second calming tank different from the first calming tank.

It is also advantageous in terms of particularly low dimensions if the actuator unit comprises at least one double-acting linear actuator comprising the first and second working chamber. Preferably, the actuator unit comprises at least one, in particular exactly one, linear actuator in form of a synchronized cylinder. The complete volume compensation between the first and the second working chamber can be advantageous to the extent that there is no compensating flow caused by a differential volume, which might have to be discharged into the calming tank via the outlet line (or one of the outlet lines; see below) and the flow throttle arranged therein.

However, depending on the individual mobility of the two skeletal structures relative to each other (e.g. the maximum adjustment angle) and the maximum force or torque requirement, another particularly preferred further embodiment may be more favourable, namely an embodiment of the actuator unit in such a way that it comprises two linear actuators working in opposite directions and designed as cross-connected differential cylinders. A “cross-connection” means that the piston working chamber is of one linear actuator and the piston rod working chamber of the other linear actuator are jointly pressurized, wherein the two linear actuators are arranged relative to the articulated connection of the second to the first skeleton structure and are coupled to the two skeleton structures in such a way that both corresponding pressurizations cause the same change in the position of the two skeleton structures relative to each other. The piston working chamber of one linear actuator and the piston rod working chamber of the other linear actuator (jointly presurized with the latter) both form a first working chamber in sense of the present invention; the same applies to the second working chamber. A particular advantage of an actuator unit configured in this way is that the articulated connection between the two skeletal structures is relieved; because by (partially or even completely) compensating for the forces acting in opposite directions, high adjustment torques can be provided with comparatively low forces acting on the joint.

Especially when using two identical linear actuators and a suitable kinematic design (i.e. a suitably positioned, typically symmetrical articulation of the two linear actuators on the two skeleton structures), it can be achieved that the volume of the first working chamber sum and the volume of the second working chamber sum change completely or at least essentially in the same amount in opposite directions relative to each other when the position of the two skeleton structures relative to each other changes, so that again no compensating flow caused by a differential volume occurs, which would have to be discharged into the calming tank via the outlet line (or one of the outlet lines) and the flow throttle arranged therein.

On the other hand, however, applications are also possible in which precisely such a compensating flow is specifically useful for a special, e.g. asymmetrical operating characteristic of the exoskeleton and is therefore desired. Here the use of two different linear actuators and/or an asymmetrical kinematic configuration is advantageous, including a possible configuration of the actuator unit in such a way that for an adjustment in one direction of movement the piston working chambers of both linear actuators are pressurized and for an adjustment in the opposite direction of movement, however, the piston rod working chambers of both linear actuators are jointly pressurized. If the force compensation described above is not decisive, only a single double-acting linear actuator configured as a differential cylinder may be used. This also has a positive effect on the weight, the required installation space and the manufacturing costs.

The advantages described above can also be realized accordingly if instead of a reversible hydraulic unit a non-reversible hydraulic unit with a downstream flow reversing valve is provided. The flow reversing valve can even be combined with the above-mentioned shut-off valve to form a valve group. By changing the pressurization of the hydraulic actuator unit by switching the flow reversing valve to change the direction of action of the hydraulic actuator unit, the pump connection which forms the pressure outlet of the hydraulic pump and which communicates with the outlet line is connected or connectable to either the first or the second working chamber of the actuator unit.

In particular in the case of a configuration of the present invention using a reversible hydraulic unit, a suction line assembly with two suction line portions which bypass the flow throttles disposed in the first and the second outlet line is provided in a further preferred embodiment. This avoids that when the flow delivery direction of the hydraulic unit is reversed, i.e. when the second working chamber of the actuator unit is pressurized by the hydraulic unit, the hydraulic fluid sucked by the actuator unit via the first pump connection from the (possibly second) calming tank must flow through the flow throttle located in the (first) outlet line. This already makes sense from an energy efficiency point of view. In particular, however, this avoids unnecessary turbulences of the hydraulic fluid supplied to the hydraulic unit, which may lead to outgassing effects, which is beneficial to system safety. In the case of a symmetrical design of the adjustment unit with two outlet lines each with a flow throttle, the suction line assembly may in particular comprise a shuttle valve or have two separate check valves.

In the following, the present invention is explained in more detail by means of preferred embodiments illustrated in the drawing. Thereby it is shown in

### BRIEF DESCRIPTION OF THE DRAWINGS

FIG. 1 is a schematic view of a first exemplary embodiment of an exoskeleton configured for coupling to a leg in accordance with the invention; and

FIG. 2 is a schematic view of a second exemplary embodiment of an exoskeleton configured for coupling to a leg in accordance with the invention.

### DETAILED DESCRIPTION OF THE PERFERRED EMBODIMENT

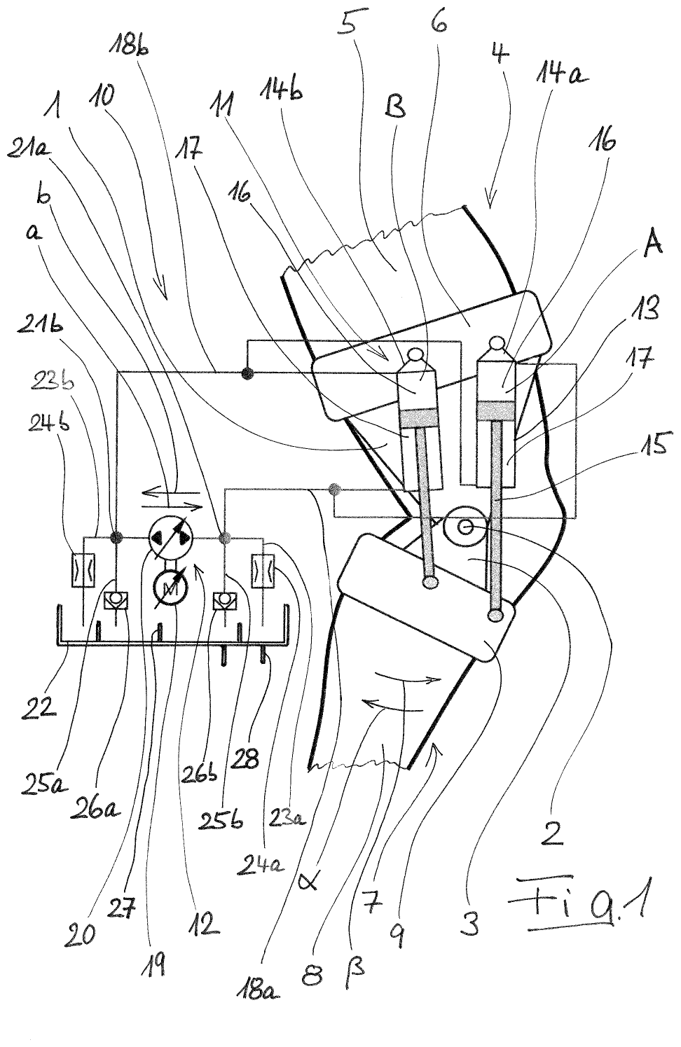

The human exoskeleton shown in FIG. 1 of the drawing in its intended use, namely coupled to a human leg, comprises a first skeletal structure 1 and a second skeletal structure 3 connected to it via a joint 2. The first skeletal structure 1 has a first coupling unit 6 suitable for coupling to a first part 4 of the leg, namely the thigh 5; and the second skeletal structure 3 has a second coupling unit 9 suitable for coupling to a second part 7 of the leg, namely the lower leg 8.

An adjustment unit 10 acts between the first skeleton structure 1 and the second skeleton structure 3. It comprises a hydraulic actuator unit 11 and a hydraulic unit 12 which acts upon it. The actuator unit 11 comprises two linear actuators 14 which are configured as double-acting differential cylinders 13. These are mechanically positively coupled to each other and operate in opposite directions in that when the second skeleton structure 3 is pivoted relative to the first skeleton structure 1 with respect to the joint 2 (arrows α, β), the piston rod 15 of one of the linear actuators 14 retracts, whereas the piston rod 15 of the other linear actuator 14 extends. The two linear actuators 14 are cross-connected in the sense that the piston working chamber 16 of one linear actuator 14a and the piston rod working chamber 17 of the other linear actuator 14b are pressurized from a common first pressure line 18a. Accordingly, the piston rod working chamber 17 of one linear actuator 14a and the piston working chamber 16 of the other linear actuator 14b are pressurized from another common second pressure line 18b.

The hydraulic unit 12 is configured to be adjustable in flow rate. For this purpose, it has a variable-speed electric motor 19. And in addition, the hydraulic pump 20 of the hydraulic unit 12 is adjustable in the flow rate. Furthermore, hydraulic unit 12 is reversible, so that it can be operated with two flow delivery directions a, b.

The first pressure line 18a and a first outlet line 23a leading to a calming tank 22 both communicate with a first pump connection 21a of the hydraulic pump 20. A first flow throttle 24a is integrated in the first outlet line 23a. The same applies to the second pump connection 21b of the hydraulic pump 20, with which not only the second pressure line 18b and the second outlet line 23b communicate, but also a first suction line portion 25a connecting the second pump connection 21b of the hydraulic pump 20 with the calming tank 22, with an integrated check valve 26a. The same applies in turn to the first pump connection 21a of the hydraulic pump 20 by communicating with a second suction line portion 25b.

To actively bend the knee by moving the second skeletal structure 3 at the joint 2 relative to the first skeletal structure 1 in the direction of arrow αα, hydraulic unit 12 is operated with the first flow delivery direction a. As a result, both the piston working chamber 16 of one linear actuator 14a and the piston rod working chamber 17 of the other linear actuator 14b are pressurized via the first pressure line 18a, so that both the piston working chamber 16 of one linear actuator 14a and the piston rod working chamber 17 of the other linear actuator 14b form a first working chamber A in this sense. At the same time hydraulic fluid is displaced via the first outlet line 23a into the calming tank 22. That hydraulic fluid which is displaced from the piston rod working chamber 17 of one linear actuator 14a and the piston working chamber 16 of the other linear actuator 14b in accordance with the movement of the second skeleton structure 3 relative to the first skeleton structure 1, passes through the second pressure line 18b to the second pump connection 21b. In the illustrated embodiment of the exoskeleton, the quantity of hydraulic fluid displaced from actuator unit 11 via the second pressure line 18b essentially corresponds to that which is supplied to actuator unit 11 via the first pressure line 18a. Thus, in absence of a significant compensating flow (see above) the quantity of hydraulic fluid which the pump 20 sucks in at its second pump connection 21b via the first suction line portion 25a from the calming tank 22 essentially corresponds to the flow rate displaced into the calming tank 22 via the first outlet line 23a. A qualitatively appropriate pressurization takes place if the exoskeleton is to resist the stretching of the leg (arrow β) by means of the body's own muscles.

To dissipate the heat loss generated by the circulation of the hydraulic fluid through the outlet line 23a, which takes place permanently parallel to the pressurization of the working chamber A, the calming tank 22 has both internal ribs 27, which are washed around by the hydraulic fluid, and external cooling fins 28, which release the corresponding waste heat to the environment. The ribs 27 additionally ensure a maximum dwell time of the hydraulic fluid in the calming tank 22 by preventing a flow-related short circuit between the outlet line 23a and the suction line portion 25a. Also the ribs 27 prevent a flow-related short circuit by their arrangement in each case between the first outlet line 23a and the second suction line portion 25b or between the second outlet line 23b and the first suction line portion 25a in such a way that hydraulic fluid (correspondingly disturbed) which reaches the calming tank 22 through an outlet line 23 and the flow throttle 24 arranged therein can be immediately sucked in again via the adjacent suction line portion 25 when the flow delivery direction of the hydraulic unit 12 is reversed.

For reverse motion sequences, i.e. to actively stretch the knee using the exoskeleton (arrow β) or to resist bending the leg (arrow a) using the body's own muscles, hydraulic unit 12 is operated in reverse direction b. In this operating mode, both the piston rod working chamber 17 of one linear actuator 14a and the piston working chamber 16 of the other linear actuator 14b form a second working chamber B which acts in the opposite direction to the first working chamber A. In a modification, the two suction line portions 25a and 25b could be part of a suction line assembly comprising a common shuttle valve; in this case, the two check valves 26a and 26b would be omitted.

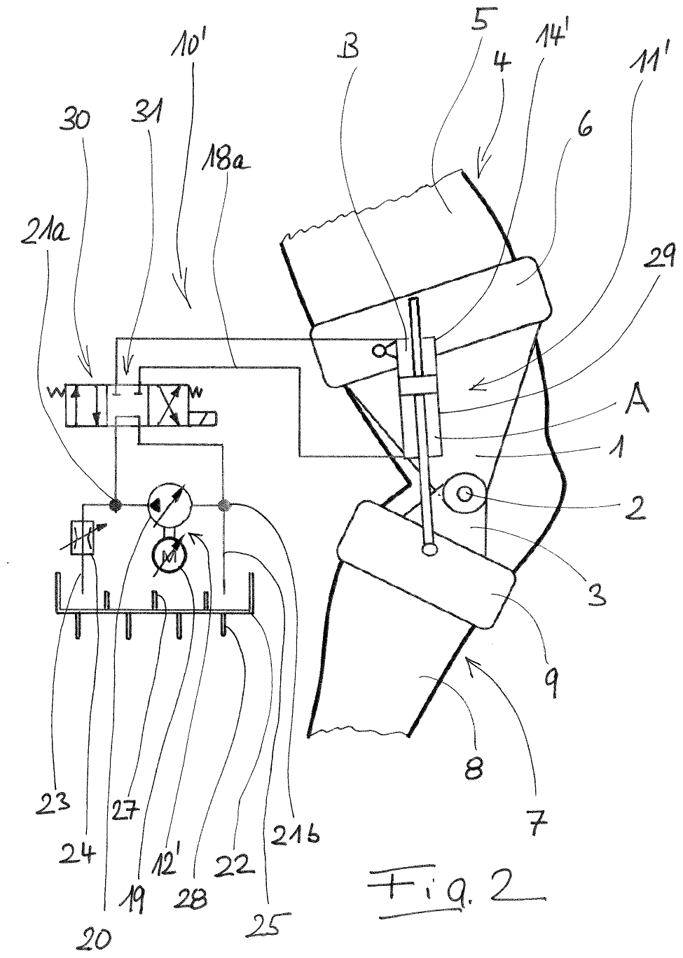

Unless otherwise stated in the following explanations, the above explanations apply accordingly to the second embodiment shown in FIG. 2 of the drawing. To avoid repetition, only the relevant differences are explained.

On the one hand, the actuator unit 11′ here comprises only a single double-acting linear actuator 14′, configures as a synchronized cylinder 29. Furthermore, instead of a reversible hydraulic unit, a non-reversible hydraulic unit 12′ with a downstream flow reversing valve 30 is provided. A shut-off functionality is additionally integrated into the flow reversing valve 30, so that it also represents a shut-off valve 31 blocking both working chambers A and B. Furthermore, the flow throttle 24 integrated in the (only) outlet line 23 is adjustable. It should be emphasized that the differences between the embodiment shown in FIG. 2 and the embodiment shown in FIG. 1 do not depend on each other, so that they can be implemented independently of each other. For example, an actuator unit as shown in FIG. 1 can also be operated using the pressure supply unit illustrated in FIG. 2. Furthermore, instead of a combined valve unit, in which the flow reversing valve 30 and the shut-off valve 31 are combined, these two valves can also be installed separately and independently of each other.

1-17. (canceled)

18. A human exoskeleton for coupling to a human body, comprising:
a first skeletal structure with a first coupling unit suitable for coupling to a first part of the human body;
a second skeletal structure connected to the first skeletal structure in an articulated manner and having a second coupling unit suitable for coupling it to a second part of the human body;
an adjustment unit acting between the first skeletal structure and the second skeletal structure, the adjustment unit comprising;
at least one hydraulic actuator unit having a working chamber; and
a hydraulic unit which acts on the at least one hydraulic actuator unit, the hydraulic unit having first and second pump connections and being configured to have an adjustable flow rate;
a pressure line connecting the working chamber of the at least one hydraulic actuator unit to the first pump connection of the hydraulic unit;
an outlet line having a flow throttle disposed therein; and
a calming tank downstream of the flow throttle;
wherein the first pump connection of the hydraulic unit is fluidly connected to the second pump connection via the outlet line and the calming tank, the outlet line having a flow therethrough when pressure is applied to the working chamber of the at least one hydraulic actuator unit.

19. The exoskeleton according to claim 18, wherein the hydraulic unit comprises a variable-speed electric motor.

20. The exoskeleton according to claim 18, wherein the hydraulic unit comprises a hydraulic pump which is adjustable in flow rate.

21. The exoskeleton according to claim 18, wherein the flow throttle is adjustable.

22. The exoskeleton according to claim 18, wherein the calming tank is configured as a closed expansion tank.

23. The exoskeleton according to claim 18, wherein:
the working chamber is a first working chamber;
the at least one actuator unit further comprises a second working chamber acting in an opposite direction to the first working chamber; and
the hydraulic unit is reversible.

24. The exoskeleton according to claim 23, further comprising:
a second pressure line connecting the second pump connection of the hydraulic unit to the second working chamber of the at least one actuator unit;
a second outlet line having a second flow throttle disposed therein, the calming tank being downstream of the second flow throttle;
wherein the second pump connection of the hydraulic unit is fluidly connected to the first pump connection via the second outlet line and the calming tank, the second outlet line having a flow therethrough when pressure is applied to the second working chamber of the at least one hydraulic unit.

25. The exoskeleton according to claim 24, wherein the at least one actuator unit comprises at least one double-acting linear actuator having the first and the second working chamber.

26. The exoskeleton according to claim 25, wherein the at least one actuator unit comprises at least one linear actuator configured as a synchronized cylinder.

27. The exoskeleton according to claim 26, wherein the at least one linear actuator comprises exactly one linear actuator.

28. The exoskeleton according to claim 24, wherein the at least one actuator unit comprises two linear actuators operating in opposite directions and configured as differential cylinders.

29. The exoskeleton according to claim 28, wherein the at least one actuator unit comprises two double-acting differential cylinders in cross-connection to one another.

30. The exoskeleton according to claim 24, further comprising a suction line assembly with two suction line portions each bypassing one of the flow throttles.

31. The exoskeleton according to claim 30, wherein the suction line assembly comprises a shuttle valve.

32. The exoskeleton according to claim 30, wherein the suction line assembly comprises two separate check valves.

33. The exoskeleton according to claim 18, wherein:
the working chamber is a first working chamber;
the at least one actuator unit further comprises a second working chamber acting in an opposite direction to the first working chamber; and
the hydraulic unit is a non-reversible hydraulic unit with a downstream flow reversing valve.

34. The exoskeleton according to claim 18, wherein the at least one hydraulic actuator unit comprises a rotary actuator.

35. The exoskeleton according to claim 18, further comprising a shut-off valve operable to shut off the at least one working chamber.
